(19) United States
(12) Patent Application Publication
(10) Pub. No.: US 2026/0302157 A1
(43) Pub. Date: Oct. 1, 2026

(54) METHOD FOR MANUFACTURING ELECTRODE COATED WITH SOLID ELECTROLYTE MEMBRANE

(71) Applicants: HYUNDAI MOTOR COMPANY, Seoul (KR); Kia Corporation, Seoul (KR)

(72) Inventors: Kyung Yup SONG, Hwaseong-si (KR); Young Jun HONG, Hwaseong-si (KR); Ye Seul PARK, Hwaseong-si (KR); Sang Hun JEONG, Hwaseong-si (KR); Do Yun KWON, Hwaseong-si (KR); So Yeon PARK, Hwaseong-si (KR); Byoung Cheon JEONG, Hwaseong-si (KR); Jae Seong HWANG, Hwaseong-si (KR)

(73) Assignees: HYUNDAI MOTOR COMPANY, Seoul (KR); Kia Corporation, Seoul (KR)

(21) Appl. No.: 19/320,532

(22) Filed: Sep. 5, 2025

(30) Foreign Application Priority Data
Mar. 26, 2025 (KR) 10-2025-0038958

(51) Int. Cl. H01M 4/04; H01M 10/0562; H01M 50/403; H01M 50/446

(52) U.S. Cl. CPC H01M 4/0407; H01M 4/0409; H01M 4/0435; H01M 4/0471; H01M 10/0562; H01M 50/403; H01M 50/446; H01M 2300/0068; H01M 2300/0082

(57) ABSTRACT

A method for manufacturing an electrode coated with a solid electrolyte membrane at least includes preparing a solid electrolyte membrane by introducing and mixing solid electrolyte powders and fibrillizable polymer powders, and by fibrillizing the fibrillizable polymer powders (S1), preparing a solid electrolyte membrane-electrode composite by placing the solid electrolyte membrane on the electrode (S2), and pressing the solid-electrolyte membrane-electrode composite by a surface-pressure press and/or a roll press such that the solid electrolyte membrane is coated on the electrode (S3).

### CROSS-REFERENCE TO RELATED APPLICATION

This application claims the benefit of priority to Korean Patent Application No. 10-2025-0038958, filed in the Korean Intellectual Property Office on Mar. 26, 2025, the entire contents of which are incorporated herein by reference in their entireties.

### TECHNICAL FIELD

The present disclosure relates to a method for manufacturing an electrode coated with a solid electrolyte membrane, and also relates to a method for manufacturing an all solid state battery using an electrode coated with a solid electrolyte membrane.

### BACKGROUND

Lithium secondary batteries have been developed as compact power sources for smartphones and other small electronic devices. With the rise of electric vehicles, the demand for these batteries has grown significantly.

A typical lithium secondary battery has a cathode and an anode, which facilitate the movement of lithium ions, and an electrolyte that enables ion transfer between the electrodes. Most lithium-ion batteries use a liquid electrolyte, formed by dissolving a lithium salt in an organic solvent. To prevent direct contact between the cathode and anode—which could cause a short circuit—a separator made of organic fibers is placed between them.

However, the organic solvents used in these electrolytes are flammable. As a result, if the battery is physically damaged and a short circuit occurs, there is a heightened risk of fire or explosion. In fact, numerous incidents have been reported due to such failures.

All All-solid-state batteries are designed by replacing the flammable liquid electrolyte with an inorganic solid electrolyte. These solid electrolytes are primarily categorized into oxide-based and sulfide-based types. Among them, sulfide-based electrolytes have attracted significant attention due to their high lithium-ion conductivity, which is comparable to that of liquid electrolytes.

However, sulfide-based electrolytes suffer from poor mechanical properties, which negatively impact both their processability and the overall stability of the battery. They are particularly brittle under applied pressure, posing challenges for large-scale manufacturing. Currently, these solid electrolytes are typically compressed into pellets on a small scale for experimental or limited-use applications.

To facilitate the mass production of sulfide-based solid electrolytes, one proposed method involves forming a composite structure by coating the solid electrolyte together with a separator, similar to those used in conventional lithium-ion batteries. This process typically involves dispersing the sulfide-based electrolyte powder in a solvent along with binder materials to create a slurry. The slurry is then cast or coated onto a substrate—often a polymeric separator—using techniques such as doctor blade coating, slot-die coating, or screen printing. After coating, the composite is dried to remove the solvent and form a solidified electrolyte layer.

However, this approach introduces several challenges. The separator adds interfacial resistance, which can diminish the high lithium-ion conductivity of the sulfide-based electrolyte. Additionally, the separator's thickness cannot be significantly reduced, limiting efforts to minimize the overall membrane thickness. This makes it difficult to achieve the compact form factor desired for high-energy-density applications.

Moreover, the use of solvents in the slurry can degrade the chemical stability of the sulfide-based electrolyte. Sulfide materials are highly sensitive to moisture and certain solvents, which can lead to decomposition, gas generation (e.g., H₂S), and a decline in ionic conductivity. These issues complicate both the processing and long-term performance of the battery.

To address the aforementioned challenges, a method has been proposed for fabricating a self-standing membrane composed of a sulfide-based solid electrolyte. This approach eliminates the need for a conventional separator and aims to simplify the battery architecture while preserving high ionic conductivity. The self-standing membrane is typically formed by compressing or casting sulfide-based electrolyte powders—often with the aid of binders or plasticizers—into a free-standing film without a supporting substrate.

However, this type of membrane tends to exhibit low tensile strength due to the brittle nature of sulfide materials and the absence of reinforcing structures. As a result, the membrane is prone to tearing or cracking during subsequent handling or cell assembly processes, posing a significant barrier to scalable manufacturing and long-term mechanical reliability. Thus, there is a need for new and improved methods for manufacturing an electrode coated with a solid electrolyte membrane.

### SUMMARY

An aspect of the present disclosure provides a method for manufacturing an electrode coated with the solid electrolyte membrane, capable of reducing a binder content to exhibit excellent ion conductivity, and of preventing process issues caused by tensile strength of a solid electrolyte membrane.

The technical problems to be solved by the present disclosure are not limited to the aforementioned problems, and any other technical problems not mentioned herein will be clearly understood from the following description by those skilled in the art to which the present disclosure pertains.
(1) The present disclosure provides a method for manufacturing an electrode coated with a solid electrolyte membrane, which includes preparing a solid electrolyte membrane by introducing and mixing solid electrolyte powders and fibrillizable polymer powders, and fibrillizing the fibrillizable polymer powders (S1), preparing a solid electrolyte membrane-electrode composite by placing the solid electrolyte membrane on an electrode (S2), and coating the solid electrolyte membrane on the electrode by pressing the solid electrolyte membrane-electrode composite by a surface-pressure press and/or a roll-press (S3).
(2) The present disclosure provides a method for manufacturing an electrode coated with a solid electrolyte membrane, in which the solid electrolyte powders are introduced in content ranging from 95 wt % to 99.9 wt %, and the fibrillizable polymer powders are introduced in content ranging from 0.1 wt % to 5 wt %, based on a total content of the solid electrolyte powders and the fibrillizable polymer powders, in ‘S1’, in (1).
(3) The present disclosure provides a method for manufacturing an electrode coated with a solid electrolyte membrane, in which the surface-pressure press is driven at pressure ranging from 50 kN to 500 kN, and at a temperature ranging from 100 °C to 140 °C, in (1) or (2).
(4) The present disclosure provides a method for manufacturing an electrode coated with a solid electrolyte membrane, in which the roll press is driven at pressure ranging from 0.5 ton/cm to 5 ton/cm, and at a temperature ranging from 100 °C to 140 °C, in any one of (1) to (3).
(5) The present disclosure provides a method for manufacturing an electrode coated with a solid electrolyte membrane, in which ‘S3’ includes pressing the solid electrolyte membrane-electrode composite by the surface-pressure press (S3_1), and pressing the solid electrolyte membrane-electrode composite by the roll press (S3_2), in any one of (1) to (4).
(6) The present disclosure provides a method for manufacturing an electrode coated with a solid electrolyte membrane, in which ‘S3_2’ is to press a result from ‘S3_1’ by the roll press, in any one of (1) to (5).
(7) The present disclosure provides a method for manufacturing an electrode coated with a solid electrolyte membrane, in which a gap between rollers of the roll press ranges from 80 μm to 150 μm, in (6).
(8) The present disclosure provides a method for manufacturing an electrode coated with a solid electrolyte membrane, in which ‘S3_1’ is to press a result from ‘S3_2’ by the surface-pressure press, in any one of (1) to (7).
(9) The present disclosure provides a method for manufacturing an electrode coated with a solid electrolyte membrane, in which a gap between rollers of the roll press ranges from 80 μm to 150 μm, in (8).
(10) The present disclosure provides a method for manufacturing an electrode coated with a solid electrolyte membrane, in which ‘S3_1’ is performed for a time ranging from 20 seconds to 1 minutes, and the rotational speed of the roll press ranges from 1 m/min to 5 m/min in ‘S3_2’, in any one of (1) to (9).
(11) The present disclosure provides a method for manufacturing an electrode coated with a solid electrolyte membrane, in which ‘S3’ includes primarily pressing the solid electrolyte membrane-electrode composite by a first surface-pressure press (S3_1a), and secondarily pressing a result from ‘S3_1a’ by a second surface-pressure press (S3_2a), in any one of (1) to (10).
(12) The present disclosure provides a method for manufacturing an electrode coated with a solid electrolyte membrane, in which ‘S3’ includes primarily pressing the solid electrolyte membrane-electrode composite by a first roll press (S3_1b), and secondarily pressing a result from ‘S3_1b’ by a second roll press (S3_2b), in any one of (1) to (11).
(13) The present disclosure provides a method for manufacturing an electrode coated with a solid electrolyte membrane, in which a gap between rollers of the second roll press is smaller than a gap between rollers of the first roll press, in any one of (1) to (12).

### BRIEF DESCRIPTION OF THE DRAWINGS

The above and other objects, features and advantages of the present disclosure will be more apparent from the following detailed description taken in conjunction with the accompanying drawings:

FIG. 1A is a non-limiting view schematically illustrating a process for preparing a solid electrolyte membrane;

FIG. 1B is a non-limiting view schematically illustrating a process for preparing a solid electrolyte membrane using a solid electrolyte self-standing membrane rolled;

FIG. 2 is a non-limiting schematic process equipment to manufacture an electrode coated with a solid electrolyte membrane according to an embodiment of the present disclosure;

FIG. 3 is a non-limiting schematic process equipment to manufacture an electrode coated with a solid electrolyte membrane according to an embodiment of the present disclosure;

FIG. 4 is a non-limiting schematic process equipment to manufacture an electrode coated with a solid electrolyte membrane according to an embodiment of the present disclosure;

FIG. 5 is a non-limiting schematic process equipment to manufacture an electrode coated with a solid electrolyte membrane according to an embodiment of the present disclosure;

FIG. 6 is a non-limiting schematic process equipment to manufacture an electrode coated with a solid electrolyte membrane according to an embodiment of the present disclosure;

FIG. 7 are views illustrating schematic process equipment to manufacture an electrode coated with a solid electrolyte membrane according to an embodiment of the present disclosure; and

FIG. 8 is a view obtained by capturing a solid electrolyte self-standing membrane prepared according to Comparative example 1.

### DETAILED DESCRIPTION

Hereinafter, the present disclosure will be described in more detail for the understanding of the present disclosure. In this case, terms or words used in the present specification and the claims should not be interpreted as commonly-used dictionary meanings, but be interpreted as to be relevant to the technical scope of the present disclosure based on the fact that the inventor may properly define the concept of the terms to explain the present disclosure in best ways.

The terms used in the present disclosure are provided only for the illustrative purpose, and the present disclosure is not limited thereto. The singular forms are intended to include the plural forms unless the context clearly indicates otherwise.

In this specification, It will be further understood that the terms “comprises,” “includes,” or “has,” specify the presence of stated features, numbers, steps, components, parts, or the combination thereof, but do not preclude the presence or addition of one or more other features, numbers, steps, components, and/or the combination thereof.

### Method for Manufacturing Electrode Coated with Solid Electrolyte Membrane

The present disclosure provides a method for manufacturing an electrode coated with a solid electrolyte membrane.

According to an embodiment of the present disclosure, the method for manufacturing the electrode coated with the solid electrolyte membrane at least includes the steps for introducing and mixing solid electrolyte powders and fibrillizable polymer powders, and fibrillizing the fibrillizable polymer powders to prepare the solid electrolyte membrane (S1), for placing the solid electrolyte membrane on the electrode to prepare a solid electrolyte membrane-electrode composite (S2), and for pressing the solid-electrolyte membrane-electrode composite by a surface-pressure press and/or a roll press such that the solid electrolyte membrane is coated on the electrode (S3).

A conventional method for preparing a solid electrolyte membrane has been known as having a negative correlation in that the content of a binder decreased, improves the ion conductivity of the solid electrolyte membrane, but decreases the mechanical properties such as tensile strength.

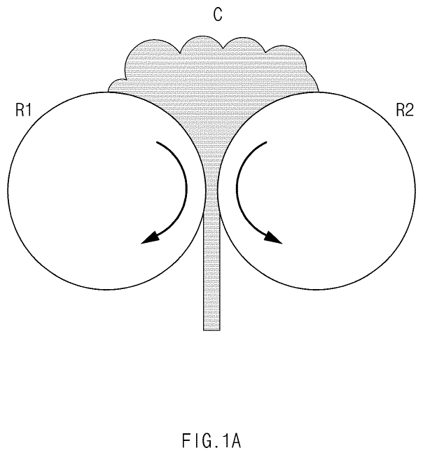

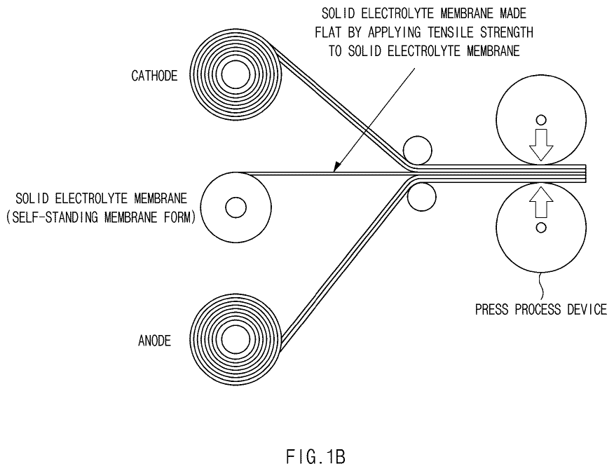

Specifically, as illustrated in FIG. 1B, a roll-to-roll process requires a press process to attach a cathode, a solid electrolyte self-standing membrane, and an anode to each other to manufacture a battery. To smoothly perform the press process through the roll-to-roll process, the tensile strength is applied to a solid electrolyte self-standing membrane to be flat. Then, the solid electrolyte self-standing membrane is introduced into a press process device to perform the press process. However, when the content of a binder is decreased to increase the ion conductivity of the solid electrolyte membrane, the solid electrolyte self-standing membrane is torn due to the tensile strength applied to the solid electrolyte self-standing membrane. Accordingly, the roll-to-roll process may not be smoothly performed. Accordingly, conventionally, to attach the solid electrolyte self-standing membrane onto the cathode or the anode through the roll-to-roll process, the content of the polymer powders allowing fibrillizing in the solid electrolyte self-standing membrane should be ensured to some extent. Accordingly, it is difficult to improve the ion conductivity.

Inventors of the present disclosure complete the present disclosure by finding out that the content of fibrillizable polymer is minimized to exhibit excellent ion conductivity and to resolve process issues caused in preparing in the form of a self-standing membrane, when a solid electrolyte membrane is overlapped and stacked on a cathode or anode through a stack process instead of a roll-to-roll process and then directly coated on the electrode through a surface-pressure press process or a roll press process, without separately preparing the self-standing membrane and applying tensile strength to the self-standing membrane through, for example, the roll-to-roll process such that the self-standing membrane is flat

Hereinafter, according to an embodiment of the present disclosure, the method for manufacturing the electrode coated with the solid electrolyte membrane will be described step by step.

According to an embodiment of the present disclosure, the method for manufacturing the electrode coated with the solid electrolyte membrane includes introducing and mixing solid electrolyte powders and fibrillizable polymer powders, and fibrillizing the fibrillizable polymer powders to prepare a solid electrolyte membrane (S1).

According to an embodiment of the present disclosure, ‘S1’ includes introducing and mixing solid electrolyte powders and fibrillizable polymer powders to prepare a mixture for a clay (S1_1).

According to an embodiment of the present disclosure, the solid electrolyte powders is the sulfide-based solid electrolyte powders, and the sulfide-based solid electrolyte powders is any one of Li₂S—P₂S₅, Li₆PS₅Cl_{0.5}Br_{0.5}, Li₂S—P₂S₅—LiI, Li₂S—P₂S5—LiCl, Li₂S—P₂S5—LiBr, Li₂S—P₂S5—Li₂O, Li₂S—P₂S5—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which ‘m’ and ‘n’ are positive integers, and ‘Z’ is one of Ge, Zn, and Ga), Li₂S—GeS₂, Li₂S—SiS₂—Li₃PO₄, Li₂S—SiS₂—LiₓMO_{y}(in which‘x’ and ‘y’ are positive numbers; ‘M’ is one of P, Si, Ge, B, Al, Ga, and In), Li₁₀GeP₂S₁₂, or the combination thereof.

According to an embodiment of the present disclosure, the average diameter (D₅₀) of the solid electrolyte powders ranges from 0.35 μm to 4 μm. Specifically, the average diameter (D₅₀) is at least 0.4 μm, at least 0.45 μm, at least 0.5 μm, at least 0.55 μm, or at least 0.6 μm, and is at most 3.8 μm, at most 3.6 μm, at most 3.4 μm, at most 3.2 μm, or at most 3 μm.

According to an embodiment of the present disclosure, the solid electrolyte powders is contained in content ranging from 95 wt % to 99.9 wt %, based on the total content of the solid electrolyte powders and the fibrillizable polymer powders. Specifically, the solid electrolyte powders is contained in content of at least 95.5 wt %, at least 96 wt %, at least 96.5 wt %, at least 97 wt %, at least 98 wt %, at least 98.5 wt %, or at least 99 wt %, and at most 99.8 wt %, at most 99.7 wt %, at most 99.6 wt %, or at most 99.5 wt %. When the content of the solid electrolyte powders satisfies the aforementioned range, the prepared solid electrolyte membrane is improved in lithium ion conductivity and tensile strength. When the content of the solid electrolyte powders exceeds the aforementioned range, the solid electrolyte membrane may neither exhibit a sufficient physical property nor be smoothly coated on the electrode, in ‘S3’ to be described. In addition, when the content of the solid electrolyte powders falls below the aforementioned range, the lithium ion conductivity is lowered.

According to an embodiment of the present disclosure, the fibrillizable polymer is any one of a butadiene rubber (BR), a nitrile butadiene rubber (NBR), a hydrogenated nitrile butadiene rubber (HNBR), a polyvinylidene difluoride (PVDF), polytetrafluoroethylene (PTFE), and carboxymethylcellulose (CMC) or the combination thereof. Specifically, the fibrillizable polymer is PTFE.

PTFE is a polymer in which all hydrogen elements of polyethylene (PE) are substituted with fluorine elements. Even though PTFE is a polymer having an aliphatic main chain, PTFE has excellent thermal stability and electrical stability. Accordingly, PTFE has been widely applied in the field of electronic materials. In particular, PTFE is mainly employed for a cathode because PTFE has high oxidation stability resulting from a low highest occupied molecular vital (HOMO) level of a polymer. Even though PTFE has a high glass transition temperature (Tg) because PTFE has a cylindrical structure, PTFE is fibrillized even at a low temperature.

According to an embodiment of the present disclosure, the fibrillizable polymer powders may have the average diameter (D₅₀) ranging from 1μm to 1,000 μm. Specifically, the average diameter (D₅₀) of the fibrillizable polymer powers is at least 10 μm, at least 50 μm, at least 100 μm, or at least 150 μm, and may at most 900 μm, at most 800 μm, at most 700 μm, or at most 600 μm.

According to an embodiment of the present disclosure, the fibrillizable polymer powders is contained in content ranging from 0.1 wt % to 2 wt %. Specifically, the fibrillizable polymer powders is contained in content of at least 0.15 wt %, at least 0.2 wt %, at least 0.25 wt %, at least 0.3 wt %, at least 0.35 wt %, or at least 0.4 wt %, and at most 1.8 wt %, at most 1.6 wt %, at most 1.4 wt %, at most 1.2 wt %, or at most 1 wt %. When the content of the fibrillizable polymer powders satisfies the aforementioned range, the prepared solid electrolyte membrane is improved in lithium ion conductivity and tensile strength. When the content of the fibrillizable polymer powders falls below the aforementioned range, the prepared solid electrolyte membrane may not exhibit sufficient physical property. Accordingly, the prepared solid electrolyte membrane is torn in the process for preparing the self-standing membrane. In addition, when the content of the fibrillizable polymer powders exceed the aforementioned range, the lithium ion conductivity is reduced.

According to an embodiment of the present disclosure, the solid electrolyte powders and the fibrillizable polymer powders is mixed in a solid phase without an additional solvent, or is resolved in a solvent to be mixed, in ‘S1_1’.

Specifically, according to an embodiment of the present disclosure, the solid electrolyte powders and the fibrillizable polymer powders is mixed in a solid phase without an additional solvent. In this case, shear stress is applied the mixture including the solid electrolyte and the fibrillizable polymer powders without the additional solvent to be clayfied. Accordingly, since the contact between the fibrillizable polymer powders and the solid electrolyte powders is minimized, the decrease in lithium-ion conductivity is significantly reduced, as compared to the use of a binder resolved in a solvent.

According to an embodiment of the present disclosure, ‘S1’ includes preparing a clay-like material by fibrillizing the fibrillizable polymer contained in the mixture to be clyfied, which is prepared in ‘S1_1’, (S2).

According to an embodiment of the present disclosure, ‘S1_2’ includes preparing a clayfied result, that is, a clay-like material by applying shear stress to the mixture to be clayfied, which is prepared in ‘S1_1’, to convert the fibrillizable polymer powders into a fibrillized polymer (S2).

According to an embodiment of the present disclosure, the fibrillized polymer may have a diameter ranging from 0.01 μm to 10 μm. Specifically, the fibrillized polymer may have the diameter of at least 0.02 μm, at least 0.04 μm, at least 0.06 μm, or at least 0.1 μm, and is at most 8 μm, at most 6 μm, at most 4 μm, or at most 2 μm. The diameter of the fibrillized polymer refers to the diameter of a cross-section obtained by taking the fibrillized polymer in a direction perpendicular to the length direction of the fibrillized polymer.

According to an embodiment of the present disclosure, the shear stress is applied through a device or a manner commonly used in an art to which the present disclosure pertains.

According to an embodiment of the present disclosure, ‘S1_2’ is performed the temperature ranging from 20 °C to 125 °C. Specifically, ‘S1_2’ is at least 22 °C, at least 24 °C, or at least 25 °C, and may at most 120 °C, at most 115 °C, at most 110 °C, at most 105 °C, or at most 100 °C. When ‘S1_2’ is performed within the aforementioned range, the fibrillizable polymer powders is easily converted to the fibrillized polymer.

According to an embodiment of the present disclosure, ‘S1_2’ is performed for the time ranging from 3 minutes to 25 minutes. Specifically, ‘S1_2’ is performed for the time of at least 4 minutes, at least 4.5 minutes, or at least 5 minutes, and at most 24 minutes, at most 23 minutes, at most 22 minutes, at most 21 minutes, or at most 20 minutes. When ‘S1_2’ is performed within the above process time range, the fibrillizable polymer powders is easily transformed to the fibrillized polymer.

According to an embodiment of the present disclosure, ‘S1’ includes extruding the solid electrolyte membrane by introducing the clay-like material C, which is prepared in ‘S1_2’, between a first roller R1 and a second roller R2 adjacent to each other (S1_3).

According to an embodiment of the present disclosure, ‘S1_3’ is performed by two-roll calendering equipment.

According to an embodiment of the present disclosure, the result in ‘S1_2’, that is, the clay-like material is introduced between rollers of the two-roll calendering equipment, compressed through inter-roller linear force and extruded in the form of a solid electrolyte membrane.

According to an embodiment of the present disclosure, the method for manufacturing the electrode coated with the solid electrolyte membrane includes placing the prepared solid electrolyte membrane on the electrode to prepare the solid electrolyte membrane-electrode composite (S2).

According to an embodiment of the present disclosure, ‘in S2’, the solid electrolyte membrane prepared is merely placed on the electrode, thereby preventing the conventional issue of tearing the solid electrolyte self-standing membrane, as the shear stress is not applied to the solid electrolyte membrane.

According to an embodiment of the present disclosure, in ‘S2’, the prepared solid electrolyte membrane-electrode composite has the structure in which the solid electrolyte membrane is placed on the electrode, and any other physical coupling or chemical bonding is not applied between the electrode and the solid electrolyte membrane. Specifically, the solid electrolyte membrane-electrode composite is prepared to perform the press process in ‘S3’ to be described below. Accordingly, the electrode and the solid electrolyte membrane are present independently from each other, without being coupled or bonded physically or chemically.

According to an embodiment of the present disclosure, the solid electrolyte membrane of the solid electrolyte membrane-electrode composite, which is prepared in ‘S1’, is cut to be matched with the size of the electrode for placing the solid electrolyte membrane, without receiving the tensile strength additionally.

According to an embodiment of the present disclosure, the electrode includes an active material layer and a base.

According to an embodiment of the present disclosure, the active material layer included in the electrode is an anode active material layer or a cathode active material layer. When the active material layer is the anode active material layer, the electrode is an anode. When the active material layer is the cathode active material layer, the electrode is a cathode. The details of the cathode active material layer and the anode active material layer will be described later.

According to an embodiment of the present disclosure, the base, which serves as a current collector, includes at least one selected from the group consisting of indium, copper, magnesium, aluminum, stainless steel, iron, and the combination thereof. The details thereof will be described below.

According to an embodiment of the present disclosure, the method for manufacturing the electrode coated with the solid electrolyte membrane includes pressing the solid-electrolyte membrane-electrode composite by a surface-pressure press and/or a roll press such that the solid electrolyte membrane is coated on the electrode (S3).

According to an embodiment of the present disclosure, in the method for manufacturing the electrode coated with the solid electrolyte membrane, the solid electrolyte membrane is directly coated on the electrode without preparing the self-standing membrane. Accordingly, the content of the fibrillizable polymer is minimized, thereby ensuring the excellent ion conductivity. When the solid electrolyte membrane is prepared in the form of the self-standing membrane, the solid electrolyte membrane is torn in the roll-to-roll process and the press process thereafter, thereby failing to manufacture the all solid state battery. According to an embodiment of the present disclosure, in the method for manufacturing the electrode coated with the solid electrolyte membrane, as the solid electrolyte membrane is coated on the electrode, the coated electrode may proceed to the following process such as the press process. Accordingly, the tensile strength is applied to the electrode coated with the solid electrolyte membrane, instead of being applied to the solid electrolyte membrane, when the press process is performed, thereby preventing various process issues caused by the tensile strength applied to the solid electrolyte membrane.

According to an embodiment of the present disclosure, the coating of the solid electrolyte membrane on the electrode (S3) is performed by pressing the solid electrolyte membrane-electrode composite through the surface-pressure press and/or roll press.

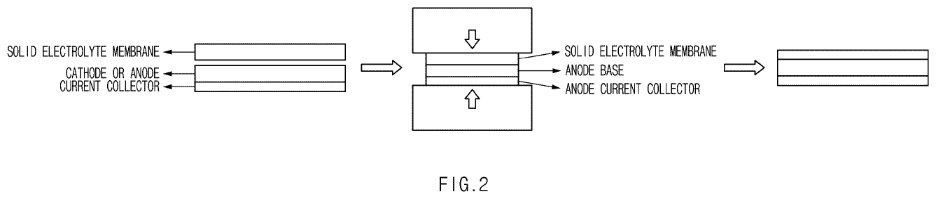

According to an embodiment of the present disclosure, ‘S3’ is performed through the pressing by the surface-pressure press, as illustrated in FIG. 2. The surface-pressure press may press a wider surface as compared to the roll press. Accordingly, the surface-pressure press allows the solid electrolyte membrane to be uniformly coated on the electrode.

According to an embodiment of the present disclosure, when ‘S3’ is performed through pressing by the surface-pressure press, the surface-pressure press is driven under the pressure ranging from 50 kN to 500 kN. Specifically, the surface-pressure press is driven under the pressure of at least 60 kN, at least 80 kN, at least 100 kN, at least 120 kN, or at least 140 kN. In addition, the surface-pressure press is driven under the pressure of at most 450 kN, at most 400 kN, at most 350 kN, at most 300 kN, or at most 250 kN. When the aforementioned range is satisfied, the interfacial adhesive force between the solid electrolyte membrane and the electrode is further improved, and the solid electrolyte membrane is more easily coated on the electrode.

According to an embodiment of the present disclosure, when ‘S3’ is performed through pressing by the surface-pressure press, the surface-pressure press is driven at the temperature from 100 °C to 140 °C. Specifically, the surface-pressure press is driven at the temperature of at least 102 °C, at least 104 °C, at least 106 °C, at least 108 °C, or at least 110 °C, and at most 138 °C, at most 136 °C, at most 134 °C, at most 132 °C, or at most 130 °C. When the aforementioned range is satisfied, the interfacial adhesive force between the solid electrolyte membrane and the electrode is further improved, and the solid electrolyte membrane is more easily coated on the electrode.

According to an embodiment of the present disclosure, when ‘S3’ is performed through pressing by the surface-pressure press, ‘S3’ is performed for a time ranging from 5 seconds to 5 minutes. Specifically, ‘S3’ is performed for a time ranging from 10 seconds to 3 minutes. More specifically, ‘S3’ is performed for a time ranging from 20 seconds to 1 minute. When the aforementioned range is satisfied, the interfacial adhesive force between the solid electrolyte membrane and the electrode is further improved, and the solid electrolyte membrane is more easily coated on the electrode.

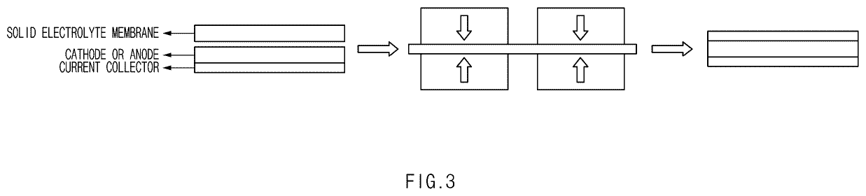

According to an embodiment of the present disclosure, as illustrated in FIG. 3, ‘S3’ includes primarily pressing the solid electrolyte membrane-electrode composite through a first surface-pressure press (S3_1a), and secondarily pressing the result from ‘S3_1a’ through a second surface-pressure press(S3_2a).

According to an embodiment of the present disclosure, the first surface-pressure press and the second surface-pressure press is driven under the pressure ranging from 50 kN to 500 kN. Specifically, the first surface-pressure press and the second surface-pressure press is driven under the pressure of at least 60 kN, at least 80 kN, at least 100 kN, at least 120 kN, or at least 140 kN. In addition, the first surface-pressure press and the second surface-pressure press is driven under the pressure of at most 450 kN, at most 400 kN, at most 350 kN, at most 300 kN, or at most 250 kN. When the aforementioned range is satisfied, the interfacial adhesive force between the solid electrolyte membrane and the electrode is further improved, and the solid electrolyte membrane is more easily coated on the electrode.

According to an embodiment of the present disclosure, the first surface-pressure press and the second surface-pressure press is performed at the temperature from 100 °C to 140 °C. Specifically, the first surface-pressure press and the second surface-pressure press is performed at the temperature of at least 102 °C, at least 104 °C, at least 106 °C, at least 108 °C, or at least 110 °C, and at most 138 °C, at most 136 °C, at most 134 °C, at most 132 °C, or at most 130 °C. When the first surface-pressure press and the second surface-pressure press satisfy the aforementioned range, the interfacial adhesive force between the solid electrolyte membrane and the electrode is further improved, and the solid electrolyte membrane is more easily coated on the electrode.

According to an embodiment of the present disclosure, ‘S3_1a’ and ‘S3_2a’ is performed for a time ranging from 5 seconds to 5 minutes. Specifically, ‘S3_1a’ and ‘S3_2a’ is performed for a time ranging from 10 seconds to 3 minutes. More specifically, ‘S3_1a’ and ‘S3_2a’ is performed for a time ranging from 10 seconds to 1 minute. When the aforementioned range is satisfied, the interfacial adhesive force between the solid electrolyte membrane and the electrode is further improved, and the solid electrolyte membrane is more easily coated on the electrode.

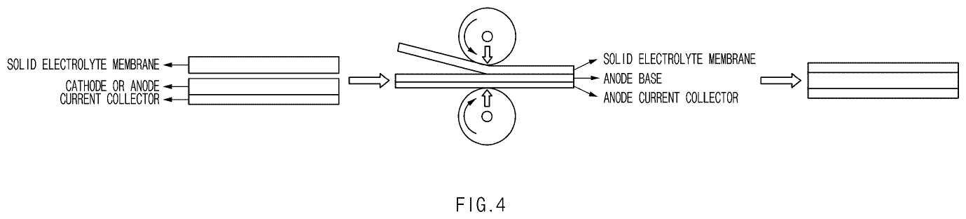

According to an embodiment of the present disclosure, as illustrated in FIG. 4, ‘S3’ is performed through the applying of pressure by the roll press. The roll press may apply linear pressure. Accordingly, the roll press may apply higher pressure, may allow the manufacturing at a more rapid process rate, and may coat the solid electrolyte membrane having an appropriate thickness on the electrode, as compared to the surface-pressure press.

According to an embodiment of the present disclosure, when ‘S3’ is performed through pressing by the roll press, the roll press is driven at pressure ranging from 0.5 ton/cm to 5 ton/cm. Specifically, the roll press is driven at pressure of at least 0.6 ton/cm, at least 0.8 ton/cm, at least 1 ton/cm, at least 1.2 ton/cm, or at least 1.4 ton/cm. In addition, the roll press is driven at pressure of at most 4.5 ton/cm, at most 4 ton/cm, at most 3.5 ton/cm, at most 3 ton/cm, or at most 2.5 ton/cm. When the aforementioned range is satisfied, the interfacial adhesive force between the solid electrolyte membrane and the electrode is further improved, and the solid electrolyte membrane is more easily coated on the electrode.

In addition, according to an embodiment of the present disclosure, when ‘S3’ is performed through pressing by the roll press, the roll press is driven at the temperature from 100 °C to 140 °C. Specifically, the roll press is driven at the temperature of at least 102 °C, at least 104 °C, at least 106 °C, at least 108 °C, or at least 110 °C, and is driven at the temperature of at most 138 °C, at most 136 °C, at most 134 °C, at most 132 °C, or at most 130 °C. When the aforementioned range is satisfied, the interfacial adhesive force between the solid electrolyte membrane and the electrode is further improved, and the solid electrolyte membrane is more easily coated on the electrode.

According to an embodiment of the present disclosure, when ‘S3’ is performed through pressing by the roll press, each of rollers of the roll press rotate at a rotational speed ranging from 1 m/min to 5 m/min. Specifically, each roller of the roll press may rotate at a rotational speed of at least 1.2 m/min, at least 1.4 m/min, at least 1.6 m/min, at least 1.8 m/min, or at least 2 m/min, and is at most 4.8 m/min, at most 4.6 m/min, at most 4.4 m/min, at most 4.2 m/min, and at most 4. When the aforementioned range is satisfied, the interfacial adhesive force between the solid electrolyte membrane and the electrode is further improved, and the solid electrolyte membrane is more easily coated on the electrode.

According to an embodiment of the present disclosure, when ‘S3’ is performed through the pressing by the roll press, the gap between rollers of the roll press is range from 80 μm to 150 μm. Specifically, the gap is at least 82 μm, at least 84 μm, at least 86 μm, at least 88 μm, or at least 90 μm, and is at most 148 μm, at most 146 μm, at most 144 μm, at most 142 μm, or at most 140 μm. When the aforementioned range is satisfied, the interfacial adhesive force between the solid electrolyte membrane and the electrode is further improved, and the solid electrolyte membrane is more easily coated on the electrode.

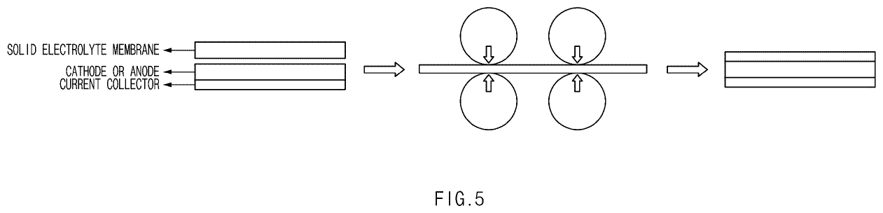

According to an embodiment of the present disclosure, as illustrated in FIG. 5, ‘S3’ includes primarily pressing the solid electrolyte membrane-electrode composite by a first roll press (S3_1b), and secondarily pressing the result from ‘S3_1b’ by a second roll press (S3_2b).

According to an embodiment of the present disclosure, each of the first roll press and the second roll press is performed at pressure ranging from 0.5 ton/cm to 5 ton/cm. Specifically, each of the first roll press and the second roll press is performed at pressure of at least 0.6 ton/cm, at least 0.8 ton/cm, at least 1 ton/cm, at least 1.2 ton/cm or at least 1.4 ton/cm, and is performed at pressure of at most 4.5 ton/cm, at most 4 ton/cm, at most 3.5 ton/cm, at most 3 ton/cm, or at most 2.5 ton/cm. When the aforementioned range is satisfied, the interfacial adhesive force between the solid electrolyte membrane and the electrode is further improved, and the solid electrolyte membrane is more easily coated on the electrode.

According to an embodiment of the present disclosure, the first roll press and the second roll press is performed at the temperature from 100 °C to 140 °C. Specifically, the first roll press and the second roll press is performed at the temperature of at least 102 °C, at least 104 °C, at least 106 °C, at least 108 °C, or at least 110 °C, and at most 138 °C, at most 136 °C, at most 134 °C, at most 132 °C, or at most 130 °C. When the aforementioned range is satisfied, the interfacial adhesive force between the solid electrolyte membrane and the electrode is further improved, and the solid electrolyte membrane is more easily coated on the electrode.

According to an embodiment of the present disclosure, each of rollers of the first roll press and the second roll press may rotate at a rotational speed ranging from 1 m/min to 5 m/min. Specifically, each of rollers for the first roll press and the second roll press may rotate at a rotational speed of at least 1.2 m/min, at least 1.4 m/min, at least 1.6 m/min, at least 1.8 m/min, or at least 2 m/min, and at most 4.8 m/min, at most 4.6 m/min, at most 4.4 m/min, at most 4.2 m/min, or at most 4 m/min. When the aforementioned range is satisfied, the interfacial adhesive force between the solid electrolyte membrane and the electrode is further improved, and the solid electrolyte membrane is more easily coated on the electrode.

According to an embodiment of the present disclosure, the gap between rollers for the first roll press and the second roll press ranges from 80 μm to 150 μm. Specifically, the gap is at least 82 μm, at least 84 μm, at least 86 μm, at least 88 μm, or at least 90 μm, and is at most 148 μm, at most 146 μm, at most 144 μm, at most 142 μm, or at most 140 μm. When the aforementioned range is satisfied, the interfacial adhesive force between the solid electrolyte membrane and the electrode is further improved, and the solid electrolyte membrane is more easily coated on the electrode.

According to an embodiment of the present disclosure, the gap between the rollers for the second roll press is smaller than the gap between the rollers for the first roll press.

In this case, the gap between the rollers for the first roll press ranges from 120 μm to 150 μm. Specifically, the gap is at least 122 μm, at least 124 μm, at least 126 μm, at least 128 μm, or at least 130 μm, and is at most 148 μm, at most 146 μm, at most 144 μm, at most 142 μm, or at most 140 μm. According to an embodiment of the present disclosure, the gap between the rollers of the second roller press ranges from 80 μm to 110 μm. Specifically, the gap is at least 82 μm, at least 84 μm, at least 86 μm, at least 88 μm, or at least 90 μm, and is at most 108 μm, at most 106 μm, at most 104 μm, at most 102 μm, or at most 100 μm. When the aforementioned range is satisfied, the interfacial adhesive force between the solid electrolyte membrane and the electrode is further improved, and the solid electrolyte membrane is more easily coated on the electrode.

According to an embodiment of the present disclosure, ‘S3’ is performed through pressing by the roll press and the surface-pressure press. Specifically, ‘S3’ includes pressing the solid electrolyte membrane-electrode composite by the surface-pressure press (S3_1) and pressing the solid electrolyte membrane-electrode composite by the roll press (S3_2).

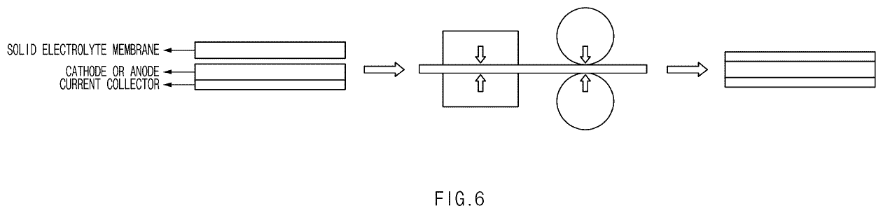

According to an embodiment of the present disclosure, as illustrated in FIG. 6, ‘S3_2’ is to press the result from ‘S3_1’ by the roll press. Specifically, the solid electrolyte membrane-electrode composite prepared in ‘S2’ is primarily pressed by the surface-pressure press, and secondarily pressed by the roll press, such that the solid electrolyte membrane is coated on the electrode. In this case, the interfacial adhesive force between the solid electrolyte membrane and the electrode is further improved, and the solid electrolyte membrane is more easily coated on the electrode.

According to an embodiment of the present disclosure, when ‘S3_2’ is to press the result from ‘S3_1’ by the roll press, the surface-pressure press is driven under the pressure ranging from 50 kN to 500 kN. Specifically, the surface-pressure press is driven under the pressure of at least 60 kN, at least 80 kN, at least 100 kN, at least 120 kN, or at least 140 kN. In addition, the surface-pressure press is driven under the pressure of at most 450 kN, at most 400 kN, at most 350 kN, at most 300 kN, or at most 250 kN. When the aforementioned range is satisfied, the interfacial adhesive force between the solid electrolyte membrane and the electrode is further improved, and the solid electrolyte membrane is more easily coated on the electrode.

According to an embodiment of the present disclosure, when ‘S3_2’ is to press the result from ‘S3_1’ by the roll press, the surface-pressure press is driven at the temperature from 100 °C to 140 °C. Specifically, the surface-pressure press is performed at the temperature of at least 102 °C, at least 104 °C, at least 106 °C, at least 108 °C, or at least 110 °C, and at most 138 °C, at most 136 °C, at most 134 °C, at most 132 °C, or at most 130 °C. When the aforementioned range is satisfied, the interfacial adhesive force between the solid electrolyte membrane and the electrode is further improved, and the solid electrolyte membrane is more easily coated on the electrode.

According to an embodiment of the present disclosure, when ‘S3_2’ is to press the result from ‘S3_1’ by the roll press, ‘S3_1’ is performed for a time ranging from 5 seconds to 5 minutes. Specifically, ‘S3_1’ is performed for a time ranging from 10 seconds to 3 minutes. More specifically, ‘S3_1’ is performed for a time ranging from 10 seconds to 1 minute. When the aforementioned range is satisfied, the interfacial adhesive force between the solid electrolyte membrane and the electrode is further improved, and the solid electrolyte membrane is more easily coated on the electrode.

According to an embodiment of the present disclosure, when ‘S3_2’ is to press the result from ‘S3_1’ by the roll press, the roll press is driven at pressure ranging from 0.5 ton/cm to 5 ton/cm. Specifically, the roll press is driven at pressure of at least 0.6 ton/cm, at least 0.8 ton/cm, at least 1 ton/cm, at least 1.2 ton/cm, or at least 1.4 ton/cm, and is driven at pressure of at most 4.5 ton/cm, at most 4 ton/cm, at most 3.5 ton/cm, at most 3 ton/cm, or at most 2.5 ton/cm. When the aforementioned range is satisfied, the interfacial adhesive force between the solid electrolyte membrane and the electrode is further improved, and the solid electrolyte membrane is more easily coated on the electrode.

According to an embodiment of the present disclosure, when ‘S3_2’ is to press the result from ‘S3_1’ by the roll press, the roll press is driven at the temperature from 100 °C to 140 °C. Specifically, the roll press is performed at the temperature of at least 102 °C, at least 104 °C, at least 106 °C, at least 108 °C, or at least 110 °C, and at most 138 °C, at most 136 °C, at most 134 °C, at most 132 °C, or at most 130 °C. When the aforementioned range is satisfied, the interfacial adhesive force between the solid electrolyte membrane and the electrode is further improved, and the solid electrolyte membrane is more easily coated on the electrode.

According to an embodiment of the present disclosure, when ‘S3_2’ is to press the result from ‘S3_1’ by the roll press, each of rollers of the roll press rotate at a rotational speed ranging from 1 m/min to 5 m/min. Specifically, each roller of the roll press may rotate at a rotational speed of at least 1.2 m/min, at least 1.4 m/min, at least 1.6 m/min, at least 1.8 m/min, or at least 2 m/min, and is at most 4.8 m/min, at most 4.6 m/min, at most 4.4 m/min, at most 4.2 m/min, and at most 4 m/min. When the aforementioned range is satisfied, the interfacial adhesive force between the solid electrolyte membrane and the electrode is further improved, and the solid electrolyte membrane is more easily coated on the electrode.

According to an embodiment of the present disclosure, when ‘S3_2’ is to press the result from ‘S3_1’ by the roll press, the gap between the rollers of the roller press ranges from 80 μm to 150 μm. Specifically, the gap between the rollers is at least 82 μm, at least 84 μm, at least 86 μm, at least 88 μm, or at least 90 μm, and is at most 140 μm, at most 130 μm, at most 120 μm, at most 110 μm, or at most 100 μm. When the aforementioned range is satisfied, the interfacial adhesive force between the solid electrolyte membrane and the electrode is further improved, and the solid electrolyte membrane is more easily coated on the electrode.

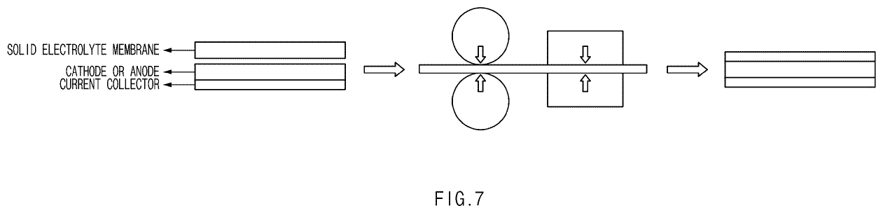

According to an embodiment of the present disclosure, as illustrated in FIG. 7, ‘S3_1’ is to press the result from ‘S3_2’ by the surface-pressure press. Specifically, the solid electrolyte membrane-electrode composite prepared in ‘S2’ is primarily pressed by the roll press, and secondarily pressed by the surface-pressure press, such that the solid electrolyte membrane is coated on the electrode. In this case, the interfacial adhesive force between the solid electrolyte membrane and the electrode is further improved, and the solid electrolyte membrane is more easily coated on the electrode. In addition, when the battery is bent after the pressing by the roll press, the battery is flat again.

According to an embodiment of the present disclosure, when ‘S3_1’ is to press the result from ‘S3_2’ by the surface-pressure press, the roll press is driven at pressure ranging from 0.5 ton/cm to 5 ton/cm. Specifically, the roll press is driven at pressure of at least 0.6 ton/cm, at least 0.8 ton/cm, at least 1 ton/cm, at least 1.2 ton/cm, or at least 1.4 ton/cm, and is driven at pressure of at most 4.5 ton/cm, at most 4 ton/cm, at most 3.5 ton/cm, at most 3 ton/cm, or at most 2.5 ton/cm. When the aforementioned range is satisfied, the interfacial adhesive force between the solid electrolyte membrane and the electrode is further improved, and the solid electrolyte membrane is more easily coated on the electrode.

According to an embodiment of the present disclosure, when ‘S3_1’ is to press the result from ‘S3_2’ by the surface-pressure press, the roll press is driven at the temperature from 100 °C to 140 °C. Specifically, the roll press is performed at the temperature of at least 102 °C, at least 104 °C, at least 106 °C, at least 108 °C, or at least 110 °C, and at most 138 °C, at most 136 °C, at most 134 °C, at most 132 °C, or at most 130 °C. When the aforementioned range is satisfied, the interfacial adhesive force between the solid electrolyte membrane and the electrode is further improved, and the solid electrolyte membrane is more easily coated on the electrode.

According to an embodiment of the present disclosure, when ‘S3_1’ is to press the result from ‘S3_2’ by the surface-pressure press, each of rollers of the roll press rotate at a rotational speed ranging from 1 m/min to 4 m/min. Specifically, each roller of the roll press may rotate at a rotational speed of at least 1.2 m/min, at least 1.4 m/min, at least 1.6 m/min, at least 1.8 m/min, or at least 2 m/min, and is at most 3.8 m/min, at most 3.6 m/min, at most 3.4 m/min, at most 3.2 m/min, and at most 3 m/min. When the aforementioned range is satisfied, the interfacial adhesive force between the solid electrolyte membrane and the electrode is further improved, and the solid electrolyte membrane is more easily coated on the electrode.

According to an embodiment of the present disclosure, when ‘S3_1’ is to press the result from ‘S3_2’ by the surface-pressure press, the gap between the rollers of the roller press ranges from 80 μm to 150 μm. Specifically, the gap between the rollers is at least 90 μm, at least 100 μm, at least 110 μm, at least 120 μm, or at least 130 μm, and is at most 148 μm, at most 146 μm, at most 144 μm, at most 142 μm, or at most 140 μm. When the aforementioned range is satisfied, the interfacial adhesive force between the solid electrolyte membrane and the electrode is further improved, and the solid electrolyte membrane is more easily coated on the electrode.

According to an embodiment of the present disclosure, when ‘S3_1’ is to press the result from ‘S3_2’ by the surface-pressure press, the surface-pressure press is driven under the pressure ranging from 50 kN to 500 kN. Specifically, the surface-pressure press is performed under the pressure of at least 60 kN, at least 80 kN, at least 100 kN, at least 120 kN, or at least 140 kN. In addition, the surface-pressure press is driven under the pressure of at most 450 kN, at most 400 kN, at most 350 kN, at most 300 kN, or at most 250 kN. When the aforementioned range is satisfied, the interfacial adhesive force between the solid electrolyte membrane and the electrode is further improved, and the solid electrolyte membrane is more easily coated on the electrode.

According to an embodiment of the present disclosure, when ‘S3_1’ is to press the result from ‘S3_2’ by the surface-pressure press, the surface-pressure press is driven at the temperature from 100 °C to 140 °C. Specifically, the surface-pressure press is driven at the temperature of at least 102 °C, at least 104 °C, at least 106 °C, at least 108 °C, or at least 110 °C, and at most 138 °C, at most 136 °C, at most 134 °C, at most 132 °C, or at most 130 °C. When the aforementioned range is satisfied, the interfacial adhesive force between the solid electrolyte membrane and the electrode is further improved, and the solid electrolyte membrane is more easily coated on the electrode.

According to an embodiment of the present disclosure, when ‘S3_1’ is to press the result from ‘S3_2’ by the surface-pressure press, ‘S3_1’ is performed for a time ranging from 5 seconds to 5 minutes. Specifically, ‘S3_1’ is performed for a time ranging from 10 seconds to 3 minutes. More specifically, ‘S3_1’ is performed for a time ranging from 10 seconds to 1 minute. When the aforementioned range is satisfied, the interfacial adhesive force between the solid electrolyte membrane and the electrode is further improved, and the solid electrolyte membrane is more easily coated on the electrode.

### Electrode Coated With Solid Electrolyte Membrane

The present disclosure provides an electrode coated with a solid electrolyte membrane.

According to an embodiment of the present disclosure, the electrode coated with the solid electrolyte membrane includes a solid electrolyte, a solid electrolyte membrane including the fibrillized polymer, and an electrode. The fibrillized polymer is contained in content ranging from 0.1 wt % to 5 wt %.

According to an embodiment of the present disclosure, the sulfide-based solid electrolyte is a component corresponding to the sulfide-based solid electrolyte powders in the manufacturing method. The sulfide-based solid electrolyte is contained, based on the whole weight of the solid electrolyte membrane, in content ranging from 95 wt % to 99.9 wt %. Specifically, the sulfide-based solid electrolyte is contained in content of at least 95.5 wt %, at least 96 wt %, at least 96.5 wt %, at least 97 wt %, at least 97.5 wt %, at least 98 wt %, at least 98.5 wt %, or at least 99 wt %, and at most 99.8 wt %, at most 99.7 wt %, at most 99.6 wt %, or at most 99.5 wt %. When the range is satisfied, the ion conductivity of the solid electrolyte membrane is improved.

According to an embodiment of the present disclosure, the fibrillizable polymer, which corresponds to the fibrillizable polymer in the manufacturing method, is contained in content ranging from 0.1 wt % to 5 wt %, based on the whole weight of the solid electrolyte membrane. Specifically, the fibrillizable polymer is contained in content of at least 0.15 wt %, at least 0.2 wt %, at least 0.25 wt %, at least 0.3 wt %, at least 0.35 wt %, or at least 0.4 wt %, and at most 4.5 wt %, at most 4.0 wt %, at most 3.5 wt %, at most 3 wt %, at most 2.5 wt %, at most 2 wt %, at most 1.5 wt % or at most 1 wt %. When the range is satisfied, the ion conductivity of the solid electrolyte membrane is improved.

As described above, when the solid electrolyte membrane EF is directly lamination-coated on the electrode EL, without being prepared in the form of the self-standing membrane. Accordingly, the content of the fibrillizable polymer powders is minimized to exhibit the excellent ion conductivity, process issues caused when the solid electrolyte membrane EF is prepared in the form of a self-standing membrane, is resolved.

### All Solid State Battery

The present disclosure provides an all solid state battery including the electrode coated with the solid electrolyte membrane.

According to an embodiment of the present disclosure, the all solid state battery is a stack structure including an anode current collector, an anode active material layer, a solid electrolyte membrane, a cathode active material layer, and a cathode current collector. The solid electrolyte membrane has been described above, so the details thereof will be omitted.

According to an embodiment of the present disclosure, the anode current collector is a base provided in the form of a plate having an electrical conductivity. Specifically, the anode current collector may have the form of a sheet, a thin film, or a foil.

According to an embodiment of the present disclosure, the anode current collector may a material which does not react with lithium. In detail, the anode current collector includes at least any one selected from Ni, Cu, stainless steel (SUS), and the combination thereof.

According to an embodiment of the present disclosure, the anode active material layer includes the anode active material, the solid electrolyte, and the binder.

According to an embodiment of the present disclosure, the anode active material is not specifically limited thereto. For example, the anode active material includes a carbon active material and a metal active material.

According to an embodiment of the present disclosure, the carbon active material is graphite, such as mesocarbon microbeads (MCMB) and highly oriented graphite (HOPG), or amorphous carbon such as hard carbon, and soft carbon.

According to an embodiment of the present disclosure, the metal active material is In, Al, Si, and Sn, and an alloy containing at least one element of In, Al, Si, and Sn.

According to an embodiment of the present disclosure, the solid electrolyte is an oxide-based solid electrolyte or a sulfide-based solid electrolyte. It is preferred that the solid electrolyte includes the sulfide-based solid electrolyte having a higher lithium ion conductivity. The details of the sulfide-based solid electrolyte have been described above. Accordingly, the details thereof will be omitted below.

According to an embodiment of the present disclosure, the conductive material is a component to form an electron transferring path within the electrode. The conductive material is a sp2 carbon material, such as carbon black, conducting graphite, ethylene black, and carbon nanotube, or graphene.

According to an embodiment of the present disclosure, the binder includes butadiene rubber (BR), nitrile butadiene rubber (NBR), hydrogenated nitrile butadiene rubber (HNBR), polyvinylidene difluoride (PVDF), polytetrafluoroethylene (PTFE), or carboxymethylcellulose (CMC).

According to an embodiment of the present disclosure, a cathode active material layer includes a cathode active material, the solid electrolyte, and the binder.

According to an embodiment of the present disclosure, the cathode active material is not specifically limited thereto. For example, the cathode electrode active material includes an oxide active material, and a sulfide active material.

According to an embodiment of the present disclosure, the oxide active material includes a rock salt type active material, such as LiCoO₂, LiMnO₂, LiNiO₂, LiVO₂, or Li₁₊ₓNi_{1/3}Co_{1/3}Mn_{1/3}O₂, a spinel type active material, such as LiMn₂O₄, or Li(Ni_{0.5}Mn_{1.5})O₄, a reverse spinel type active material, such as LiNiVO₄, or LiCoVO₄, an olivine-type active material, such as LiFePO₄, LiMnPO₄, LiCoPO₄, or LiNiPO₄, a silicon-containing active material, such as Li₂FeSiO₄, or Li₂MnSiO₄, a rock salt type active material, such as LiNi_{0.8}Co_{(0.2-x}AlₓO₂(0≤x≤0.2), which is obtained by substituting a portion of transition metal with a heterogeneous metal, a spinel-type active material, such as Li₁₊ₓMn_{2-x-y}M_{y}O₄ (M is at least one of Al, Mg, Co, Fe, Ni, and Zn; 0<x+y<2), which is obtained by substituting a portion of the transition metal with a heterogeneous metal, or lithium titanate such as Li₄Ti₅O₁₂.

According to an embodiment of the present disclosure, the sulfide active material is copper chevrel, iron sulfide, cobalt sulfide, or nickel sulfide.

According to an embodiment of the present disclosure, the solid electrolyte is an oxide-based solid electrolyte or a sulfide-based solid electrolyte. It is preferred that the solid electrolyte includes the sulfide-based solid electrolyte having a higher lithium ion conductivity.

According to an embodiment of the present disclosure, the conductive material and the binder have been described above, and the details thereof will be omitted below.

According to an embodiment of the present disclosure, the cathode current collector is a base provided in the form of a plate having an electrical conductivity. In detail, the cathode electrode current collector may have the form of a sheet or a thin film.

According to an embodiment of the present disclosure, the cathode current collector includes at least one selected from the group consisting of indium, copper, magnesium, aluminum, stainless steel, iron, and the combination thereof.

According to an embodiment of the present disclosure, the solid electrolyte membrane is positioned between the anode active material layer and the cathode active material layer to transfer a lithium ion.

Hereinafter, an embodiment of the present disclosure will be described in detail such that those skilled in the art may easily reproduce the embodiment of the present disclosure. However, the present disclosure is implemented in various forms, and is limited to embodiments described herein.

### PREPARATION EXAMPLE 1

99 wt % of sulfide-based solid electrolyte powders of Li₆PS₅Cl_{0.5}Br_{0.5} and 1 wt % of polytetrafluoroethylene powder were put in a mortar bowl, and mixed in a solid phase at lower pressure without an additional solvent.

It is recognized that the above polytetrafluoroethylene powder was fibrillized by applying shear stress at 100 °C for about 5 minutes and the above mixture was clayfied, thereafter.

The clayfied material obtained was introduced between the first roller and the second roller of the two roll calendering equipment, and five rolling processes were performed to prepare the solid electrolyte membrane.

### Example 1

The solid electrolyte membrane prepared in Preparation Example 1 was placed on the electrode, and was primarily pressed against the electrode by the surface-pressure press (pressure: 150 kN, temperature: 120 °C, time: 30 seconds). Thereafter, the result was secondarily pressed by the roll press (gap between rolls: 100 μm, pressure: 2 ton/cm, temperature: 120 °C, rotational speed: 2 m/min) to prepare the electrode coated with the solid electrolyte membrane.

### Example 2

The solid electrolyte membrane prepared in Preparation Example 1 was placed on the electrode, and was primarily pressed against the electrode by the roll press (gap between rolls: 130 μm, pressure: 2 ton/cm, temperature: 120 °C, rotational speed: 2 m/min). Thereafter, the result was secondarily pressed by the surface-pressure press (pressure: 150 kN, temperature: 120 °C, time: 30 seconds) to prepare the electrode coated with the solid electrolyte membrane.

### Example 3

The solid electrolyte membrane prepared in Preparation Example 1 was placed on the electrode, and was primarily pressed against the electrode by the first roll press (gap between rolls: 130 μ, pressure: 2 ton/cm, temperature: 120 °C, rotational speed: 2 m/min). Thereafter, the result was secondarily pressed by the second roll press (gap between rolls: 100 μm, pressure: 2 ton/cm, temperature: 120 °C, rotational speed: 2 m/min) to prepare the electrode coated with the solid electrolyte membrane.

### Example 4

The solid electrolyte membrane prepared in Preparation Example 1 was placed on the electrode, and was primarily pressed against the electrode by the first surface-pressure press (pressure: 150 kN, temperature: 120 °C, time: 30 seconds). Thereafter, the result was secondarily pressed by the second surface-pressure press (pressure: 150 kN, temperature: 120 °C, time: 30 seconds) to prepare the electrode coated with the solid electrolyte membrane.

### Example 5

The solid electrolyte membrane prepared in Preparation Example 1 was placed on the electrode, and was pressed against the electrode by the surface-pressure press (pressure: 150 kN, temperature: 120 °C, time: 30 seconds) to prepare the electrode coated with the solid electrolyte membrane.

### Example 6

The solid electrolyte membrane prepared in Preparation Example 1 was placed on the electrode, and was pressed against the electrode by the roll press (gap between rolls: 100 μm, pressure: 2 ton/cm, temperature: 120 °C, rotational speed: 2 m/min) to prepare the electrode coated with the solid electrolyte membrane.

### COMPARATIVE EXAMPLE 1

99 wt % of sulfide-based solid electrolyte powders of Li₆PS₅Cl_{0.5}Br_{0.5} and 1 wt % of polytetrafluoroethylene powder were mixed, using a mixer, in a solid phase without an additional solvent. Thereafter, the mixture of the sulfide-based solid electrolyte powders and the polytetrafluoroethylene powders was put into the mortar bowl. Then, shear stress was applied to the result at 100 °C for about 5 minutes. Accordingly, it is recognized that the polytetrafluoroethylene powders was fibrillized, and the mixture was clayfied.

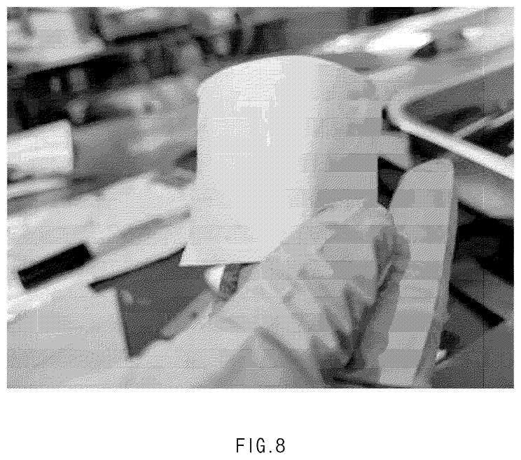

The clayfied mixture was introduced between the first roller and the second roller of the two roll calendering equipment, and five rolling processes was performed to prepare the solid electrolyte membrane. The solid electrolyte membrane is illustrated in FIG. 8.

According to an example of the present disclosure, the electrode coated with the solid electrolyte membrane is reduced in binder content. Accordingly, the excellent ion conductivity is obtained. In addition, according to an example of the present disclosure, the solid electrolyte membrane is lamination-coated on the electrode. Accordingly, the components constituting the electrode coated with the solid electrolyte membrane is integrally bent without being separated from each other, thereby exhibiting the excellent bending properties. Accordingly, according to an example of the present disclosure, even though the electrode coated with the solid electrolyte membrane has a smaller content of binder, the electrode is free from the tensile strength required in the subsequent roll-to-roll process.

Referring to FIG. 8 illustrating the solid electrolyte membrane according to Comparative example 1, when the solid electrolyte membrane is prepared in the form of the self-standing membrane without coating the solid electrolyte membrane on the electrode, the solid electrolyte membrane is furrowed. Accordingly, the solid electrolyte membrane prepared in the form of the self-standing membrane may not smoothly make contact with the electrode through the subsequent process. In addition, for the solid electrolyte membrane according to Comparative example 1, the calendering is performed in the length direction (MD). Accordingly, since it is relatively difficult for the polytetrafluoroethylene powders to be fibrillized in a width direction (TD), the tensile strength in the width direction (TD) is lower than the tensile strength in the length direction (MD). Accordingly, the solid electrolyte membrane is torn in the width direction (TD) in the subsequent roll-to-roll process.

As described above, according to an example of the present disclosure, in the method for manufacturing the electrode coated with the solid electrolyte membrane, the solid electrolyte membrane is directly coated on the electrode, thereby preventing the process issues caused by the tensile strength of the solid electrolyte membrane and reducing the binder content to exhibit the excellent ion conductivity.

Hereinabove, although the present disclosure has been described with reference to exemplary examples and the accompanying drawings, the present disclosure is not limited thereto, but is variously modified and altered by those skilled in the art to which the present disclosure pertains without departing from the spirit and scope of the present disclosure claimed in the following claims.

What is claimed is:

1. A method for manufacturing an electrode coated with a solid electrolyte membrane, the method comprising:
preparing a solid electrolyte membrane by introducing and mixing solid electrolyte powders and fibrillizable polymer powders, and by fibrillizing the fibrillizable polymer powders (S1);
preparing a solid electrolyte membrane-electrode composite by placing the solid electrolyte membrane on an electrode (S2); and
coating the solid electrolyte membrane on the electrode by pressing the solid electrolyte membrane-electrode composite by a surface-pressure press and/or a roll-press (S3).

2. The method of claim 1, wherein the solid electrolyte powders are introduced in content ranging from 95 wt % to 99.9 wt %, and the fibrillizable polymer powders are introduced in content ranging from 0.1 wt % to 5 wt %, based on a total content of the solid electrolyte powders and the fibrillizable polymer powders, in ‘S1’.

3. The method of claim 1, wherein the surface-pressure press is driven, at pressure ranging from 50 kN to 500 kN, and at a temperature ranging from 100 °C to 140 °C.

4. The method of claim 1, wherein the roll press is driven at pressure ranging from 0.5 ton/cm to 5 ton/cm, and at a temperature ranging from 100 °C to 140 °C.

5. The method of claim 1, wherein ‘S3’ includes:
pressing the solid electrolyte membrane-electrode composite by the surface-pressure press (S3_1); and
pressing the solid electrolyte membrane-electrode composite by the roll press (S3_2).

6. The method of claim 5, wherein S3_2 is to press a result from ‘S3_1’ by the roll press.

7. The method of claim 6, wherein a gap between rollers of the roll press ranges from 80 μm to 150 μm.

8. The method of claim 5, wherein S3_1 is to press a result from ‘S3_2’ by the surface-pressure press.

9. The method of claim 8, wherein a gap between rollers of the roll press ranges from 80 μm to 150 μm.

10. The method of claim 5, wherein ‘S3_1’ is performed for a time ranging from 20 seconds to 1 minute, and
wherein, in ‘S3_2’, a rotational speed of the roll press ranges from 1 m/min to 5 m/min.

11. The method of claim 1, wherein ‘S3’ includes:
primarily pressing the solid electrolyte membrane-electrode composite by a first surface-pressure press (S3_1a); and
secondarily pressing a result from ‘S3_1a’ by a second surface-pressure press (S3_2a).

12. The method of claim 1, wherein ‘S3’ includes:
primarily pressing the solid electrolyte membrane-electrode composite by a first roll press (S3_1b); and
secondarily pressing a result from ‘S3_1b’ by a second roll press (S3_2b).

13. The method of claim 12, wherein a gap between rollers of the second roll press is smaller than a gap between rollers of the first roll press.
